(19) United States
(12) Patent Application Publication
(10) Pub. No.: US 2006/0237453 A1
(43) Pub. Date: Oct. 26, 2006

(54) Fan module and fan duct thereof

(75) Inventors: Po-Hao Yu, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/370,990

(22) Filed: Mar. 9, 2006

(30) Foreign Application Priority Data
Apr. 22, 2005 (TW) 094112958

(51) Int. Cl. H05B 6/64

(52) U.S. Cl. 219/757

(57) ABSTRACT

A fan duct, which is adapted to be used with a fan, includes a body, a guiding part and at least one supporting element. The body has an accommodating space, and the guiding part is disposed therein. The guiding part has a first end surface and a second end surface, and the area of the first end surface is larger than that of the second end surface. The supporting element is disposed in the accommodating space for connecting the guiding part and the body.

This Non-provisional application claims priority under U.S.C.§ 119(a) on Patent Application No(s). 094112958, filed in Taiwan, Republic of China on Apr. 22, 2005, the entire contents of which are hereby incorporated by reference.

### BACKGROUND OF THE INVENTION

1. Field of Invention

The present invention relates to a module and a duct thereof, and more particularly to a fan module and a fan duct thereof.

2. Related Art

Due to rapid development of technology, electronic apparatuses such as computers have become necessities for life. However, accompanying to the amount of transistors within a unit area of an electronic apparatus is more and more increasing and lots of functional modules are integrated into the electronic apparatus, which cause much heat generated from the electronic apparatus during its operation.

Generally, the working temperature of the transistors and the transformers in a computer system raises when they operate over a period of time. When the working temperature is too high, the computer system will be unstable or even crashed.

In order to maintain the electronic apparatus within its operation temperature range, a fan and a heat sink are used in dissipating the heat. As shown in FIG. 1, a conventional heat dissipating structure 1 includes a heat sink 10 and a fan 20. The heat sink 10 and the fan 20 are sequentially disposed above a heat source (such as central processing unit, CPU). Heat generated from the heat source will be transferred to the heat sink 10 and then be dissipated to outside. Also, the fan 20 provides airflows for increasing dissipating effect of the heat sink 10.

In order to meet the requirements of the computer system, such as multi-function and fast processing speed, the voltage and working frequency are correspondingly increased, which raises the working temperature of the computer system. In order to maintain the working temperature with an appropriate working temperature range, it is necessary to improve the dissipating efficiency.

Conventionally, by enlarging or prolonging blades of the fan 20, by raising rotating speed of the fan 20 or by using more than one fan 20 may raise heat dissipating efficiency. However, the airflow generated by the fan 20 is not guided into the heat sink 10 and is outwardly spread far away from the fan 20. As the result, there is no enough airflow sent to the heat sink 10 and thus heat cannot be effectively dissipated.

It is therefore an important subject of the present invention to provide a fan module and a fan duct capable of effectively dissipating heat and solving above-mentioned problems.

### SUMMARY OF THE INVENTION

In view of the foregoing, the present invention is to provide a fan module and a fan duct capable of effectively dissipating heat.

To achieve the above, a fan duct according to the present invention is disclosed. The fan duct is adapted to be used with a fan and includes a body, a guiding part and at least one supporting element. In the present invention, the body has an accommodating space, and the guiding part is disposed in the accommodating space. The guiding part has a first end surface and a second end surface, and the area of the first end surface is larger than that of the second end surface. The supporting element is disposed in the accommodating space for connecting the guiding part and the body.

To achieve the above, a fan module according to the present invention is also disclosed. The fan module includes a fan and at least one fan duct. The fan duct is coupled to the fan and includes a body, a guiding part and at least one supporting element. The body has an accommodating space, and the guiding part is disposed in the accommodating space. The guiding part has a first end surface and a second end surface, and the area of the first end surface is larger than that of the second end surface. The supporting element is disposed in the accommodating space for connecting the guiding part and the body.

### BRIEF DESCRIPTION OF THE DRAWINGS

The present invention will become more fully understood from the detailed description given herein below illustration only, and thus is not limitative of the present invention, and wherein:

FIG. 1 is a schematic view showing a conventional heat dissipating structure;

FIG. 2 is a schematic view showing a fan duct and a fan according to a preferred embodiment of the present invention;

FIGS. 3A and 3B are cross-sectional views showing different preferred embodiments of a fan duct according to the present invention;

FIG. 4 is a schematic view showing a preferred embodiment of a fan module according to the present invention; and

FIG. 5 is a schematic view showing another embodiment of a fan module according to the present invention.

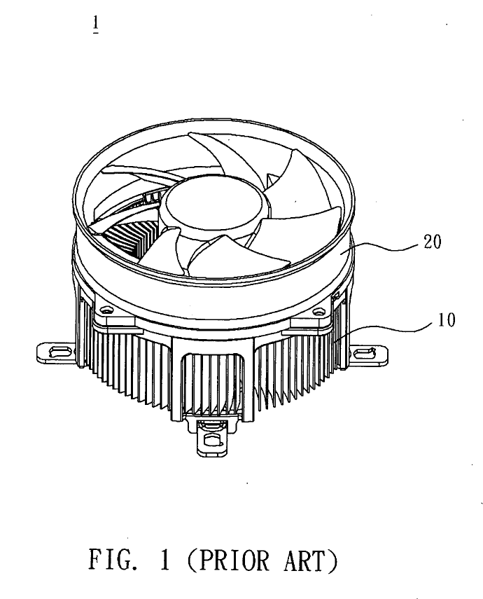

### DETAILED DESCRIPTION OF THE INVENTION

The present invention will be apparent from the following detailed description, which proceeds with reference to the accompanying drawings, wherein the same references relate to the same elements.

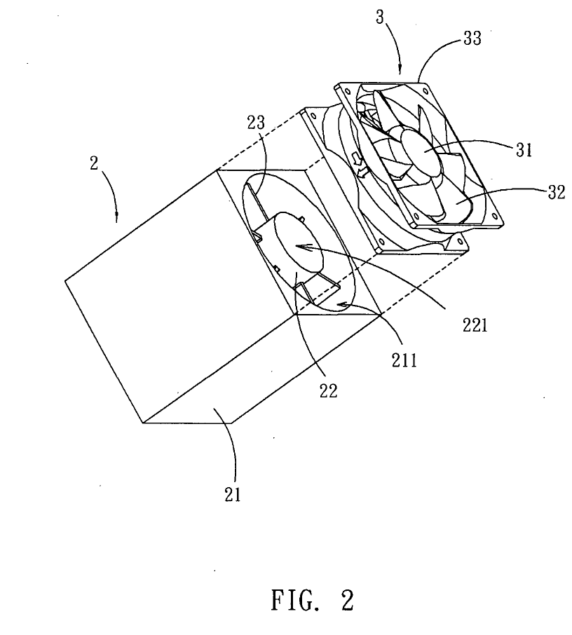

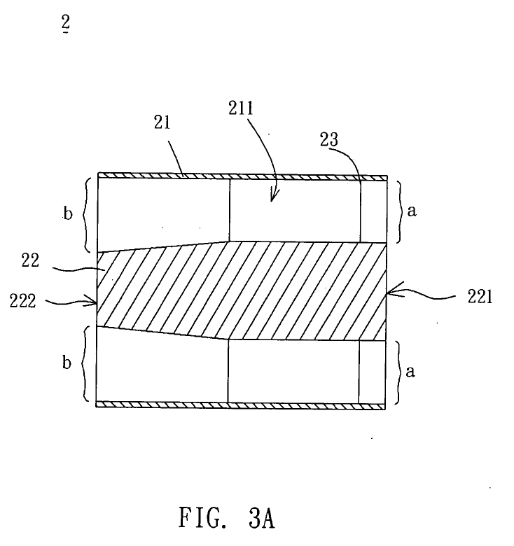

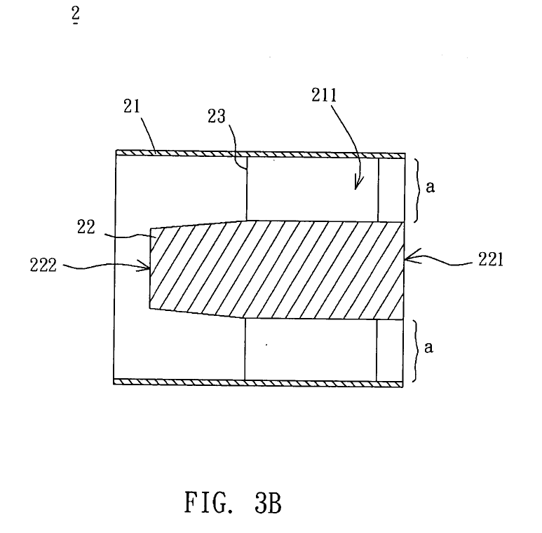

As shown in FIGS. 2 and 3, a preferred embodiment of a fan duct 2 according to the present invention is adapted to be used with a fan 3, and includes a body 21, a guiding part 22 and at least one supporting element 23.

The body 21 has an accommodating space 211, and the guiding part 22 is disposed in the accommodating space 211. The guiding part 22 has a first end surface 221 and a second end surface 222, as shown in FIG. 3A. The area of the first end surface 221 is larger than that of the second end surface 222. In this embodiment, the guiding part 22 is a preferred taper with a flat top side (i.e. the end surface is flat). The first end surface 221 and the second end surface 222 are located at two ends of the guiding part 22, respectively.

As shown in FIG. 2, the supporting element 23 is disposed in the accommodating space 211 and is disposed between the guiding part 22 and the body 21 for connecting the guiding part 22 and the body 21 so as to support the fan duct 2. Further, the supporting element 23 is preferably a rib or a stationary blade.

In FIG. 3A, the guiding part 22 extends from one end to the other end of the body 21. Also, because the area of the first end surface 221 is larger than that of the second end surface 222, an opening dimension “a” of the first end surface 221 is smaller than an opening dimension “b” of the second end surface 222. Alternatively, the guiding part 22 may extend from one end to the interior of the body 21, so that the second end surface 222 of the guiding part 22 may be located within the accommodating space 211 of the body 21, as shown in FIG. 3B.

According to practical requirements, the body 21, the guiding part 22 and the supporting element 23 are separate elements and are combined together to form the fan duct 2, or the body 21, the guiding part 22 and the supporting element 23 are integrally formed as a single unit when they are manufactured. That is to say, the fan duct 2 is a single element.

As shown in FIG. 2, the fan 3 includes a hub 31, a plurality of blades 32 and a housing 33. The hub 31 is disposed corresponding to the first end surface 221 of the guiding part 22. Also, the hub 31 and the guiding part 22 are disposed with respect to the same axial line. The blades 32 are positioned corresponding to the area which is between the guiding part 22 and the body 21 in a projection direction. In this embodiment, the hub 31 of the fan 3 is disposed corresponding to the first end surface 221, and the housing 33 is coupled to the body 21 of the fan duct 2 so that the fan 3 is jointed with the fan duct 2. The area of the first end surface 221 of the guiding part 22 is substantially equal to that of the hub 31 of the fan 3. In addition, the fan 3 may be an axial fan or a centrifugal fan.

As shown in FIG. 2 and FIG. 3A, when the fan duct 2 is located close to the outlet of the fan 3, the airflow generated by the fan 3 is guided into the fan duct 2. In view of the opening dimension “b” being larger than the opening dimension “a”, the airflow guided into the fan duct 2 is modulated so that the dynamic pressure and airflow speed are increased.

Alternatively, when the fan duct 2 is located close to the inlet of the fan 3, the airflow enters the fan 3 prior to passing through the fan duct 2. In view of the opening dimension “a” is smaller than the opening dimension “b”, the airflow is guided by the fan duct 2 to reach the blades 32 only but not reach the hub 31. As the results, it will concentrate the airflow intake and make sure that all airflow entering the fan 3 is totally used so that the performance is improved.

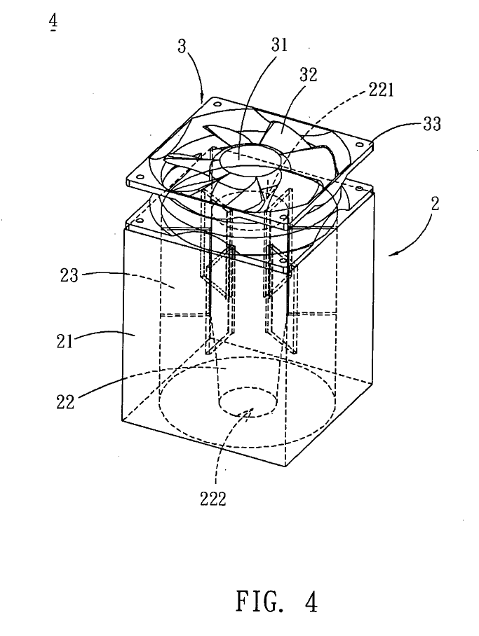

Furthermore, referring to FIG. 4, a preferred embodiment of a fan module 4 according to the present invention includes a fan 3 and at least one fan duct 2. The fan duct 2 is coupled to the fan 3 and includes a body 21, a guiding part 22 and at least one supporting element 23.

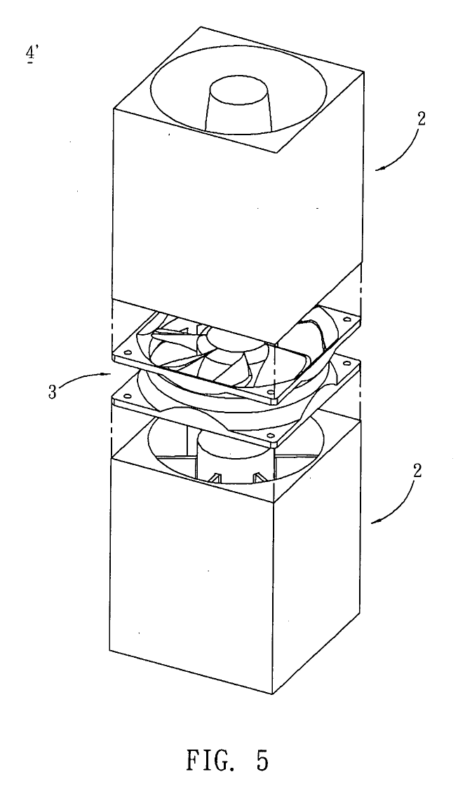

The fan duct 2 has the same construction and function as described above. The corresponding descriptions are omitted for concise purpose. The connection between the fan duct 2 and the fan 3 is also the same as described above. The first end surface 221 of the fan duct 2 may be disposed at an inlet or outlet of the fan 3 for raising dynamic pressure and stream speed or concentrating the airflow to improve the heat-dissipating quality. Or, the fan module 4 may include two fan ducts 2 disposed adjacently at the outlet of the fan 3. Or, the fan module 4′ may include two fan ducts 2 disposed at the inlet and outlet of the fan 3, respectively, as shown in FIG. 5.

In summary, an airflow is guided by the body and the guiding part with different area at both ends of the fan duct so that dynamic pressure and stream speed of the fan can be increased. Compared with the prior art, because the area of the first end surface is larger than that of the second end surface, an opening dimension between the first end surface and the body is smaller than that between the second end surface and the body. When the first end surface of the fan duct is coupled to the fan and the fan duct is located at the outlet of the fan, the dynamic pressure and stream speed of the fan is increased, and thereby the fan module including the fan and the fan duct can dissipate heat more effectively. In addition, when the fan duct is located close to the inlet of the fan, the airflow intake is concentrated to make sure that all airflow entering the fan is totally used so that the heat-dissipating quality is improved.

Although the present invention has been described with reference to specific embodiments, this description is not meant to be construed in a pivoting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fan duct adapted to be used with a fan, comprising:
a body having an accommodating space;
a guiding part disposed in the accommodating space, wherein the guiding part has a first end surface and a second end surface, and the area of the first end surface is larger than that of the second end surface; and
at least one supporting element disposed in the accommodating space for connecting the guiding part and the body.

2. The fan duct according to claim 1, wherein the guiding part comprises a taper with a flat top side.

3. The fan duct according to claim 1, wherein the fan is an axial fan or a centrifugal fan.

4. The fan duct according to claim 1, wherein the fan comprises a hub, a plurality of blades, and a housing coupled to the body, and the hub is disposed corresponding to the first end surface of the guiding part.

5. The fan duct according to claim 4, wherein the area of the first end surface of the guiding part is substantially equal to that of the hub.

6. The fan duct according to claim 1, wherein the supporting element is a rib or a stationary blade.

7. The fan duct according to claim 1, wherein the guiding part extends from one end to the other end of the body.

8. The fan duct according to claim 1, wherein the second end surface of the guiding part is located within the accommodating space.

9. The fan duct according to claim 1, wherein the body, the guiding part and the supporting element are integrally formed as a single unit.

10. A fan module, comprising:
a fan; and
a first fan duct coupled to the fan and comprising a body, a guiding part and at least one supporting element, wherein the body has an accommodating space, the guiding part is disposed in the accommodating space and has a first end surface and a second end surface, the area of the first end surface is larger than that of the second end surface, and the supporting element is disposed in the accommodating space for connecting the guiding part and the body.

11. The fan module according to claim 10, wherein the guiding part comprises a taper with a flat top side.

12. The fan module according to claim 10, wherein the fan is an axial fan or a centrifugal fan.

13. The fan module according to claim 10, wherein the fan comprises a hub, a plurality of blades and a housing coupled to the body, and the hub is disposed corresponding to the first end surface of the guiding part.

14. The fan module according to claim 13, wherein the area of the first end surface of the guiding part is substantially equal to that of the hub.

15. The fan module according to claim 10, wherein the supporting element is a rib or a stationary blade.

16. The fan module according to claim 10, wherein the guiding part extends from one end to the other end of the body.

17. The fan module according to claim 10, wherein the second end surface of the guiding part is located within the accommodating space.

18. The fan module according to claim 10, wherein the body, the guiding part and the supporting element are integrally formed as a single unit.

19. The fan module according to claim 10, wherein the first end surface of the first fan duct is located close to an inlet or outlet of the fan.

20. The fan module according to claim 10, further comprising a second fan duct, wherein the first fan duct and the second fan duct are disposed at inlet and outlet of the fan, respectively.
